(19) United States
(12) Patent Application Publication
(10) Pub. No.: US 2010/0313253 A1
(43) Pub. Date: Dec. 9, 2010

(54) METHOD, SYSTEM AND PROCESS FOR AUTHENTICATING THE SENDER, SOURCE OR ORIGIN OF A DESIRED, AUTHORIZED OR LEGITIMATE EMAIL OR ELECTRINIC MAIL COMMUNICATION

(75) Inventor: Walter Stanley Reiss, Bethlehem, PA (US)

Correspondence Address: WALTER STANLEY REISS, 414 WEST MARKET STREET, BETHLEHEM, PA, 18018, US

(73) Assignee: Walter Stanley Reiss, Bethlehem, PA (US)

(21) Appl. No.: 12/481,545

(22) Filed: Jun. 9, 2009

(51) Int. Cl. H04L 9/32; G06F 21/00; G06F 15/16

(52) U.S. Cl. 726/7; 709/206

(57) ABSTRACT

A method, system and process through which Email recipients may immediately and visually authenticate the source from which an Email originated without needing to open the Email or explore its content. This will allow a recipient to accurately segregate all desired, legitimate Email from that which is either unwanted, unexpected, illegal, malicious, potentially harmful or criminal in nature. An Email Sender must first require each proposed Email recipient to create and supply them with a unique word or code that the recipient should be prepared to identify later. The Sender must then insert this “Secret Word” within the subject heading of all subsequent Emails dispatched to that same recipient, so the recipient may then visually authenticate the legitimacy of the correspondence. All subsequent Emails purporting to be from that Sender that do not contain the correct “Secret Word” should be unopened and discarded.

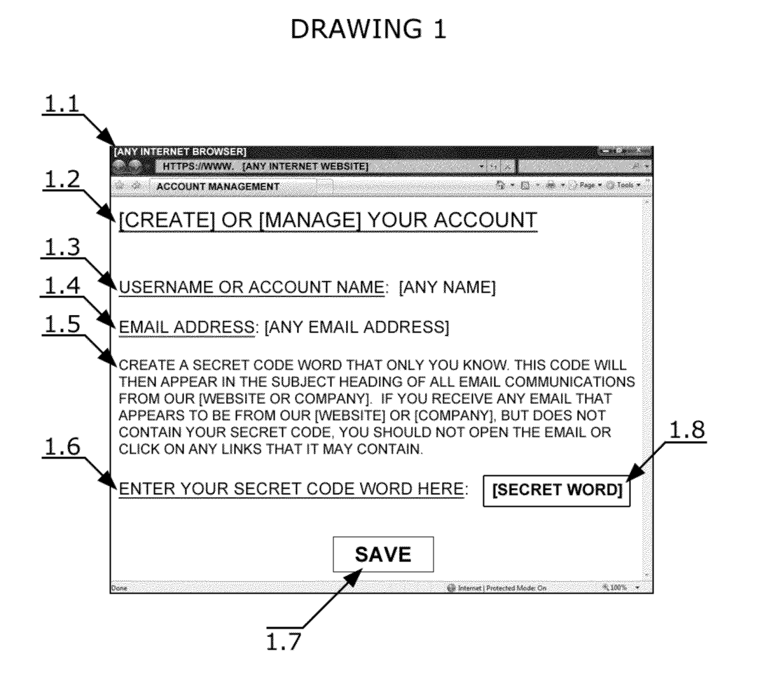

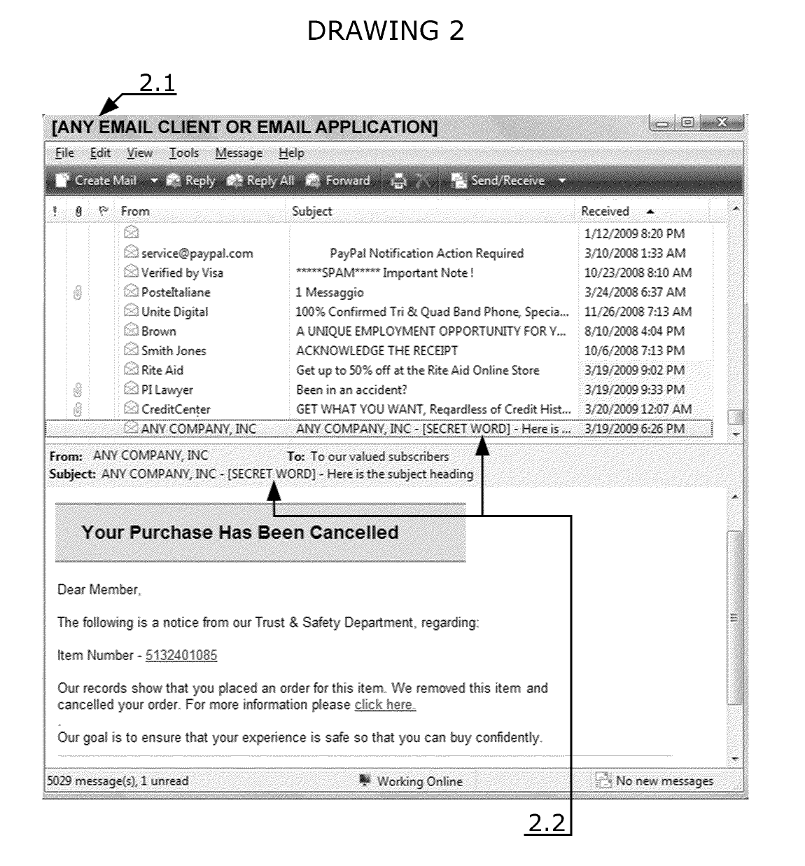

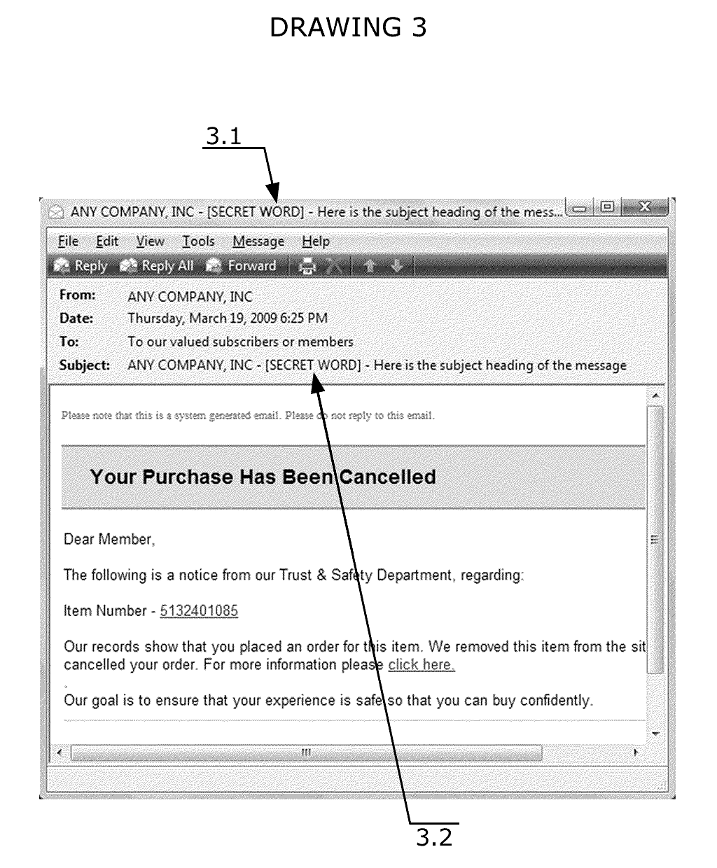

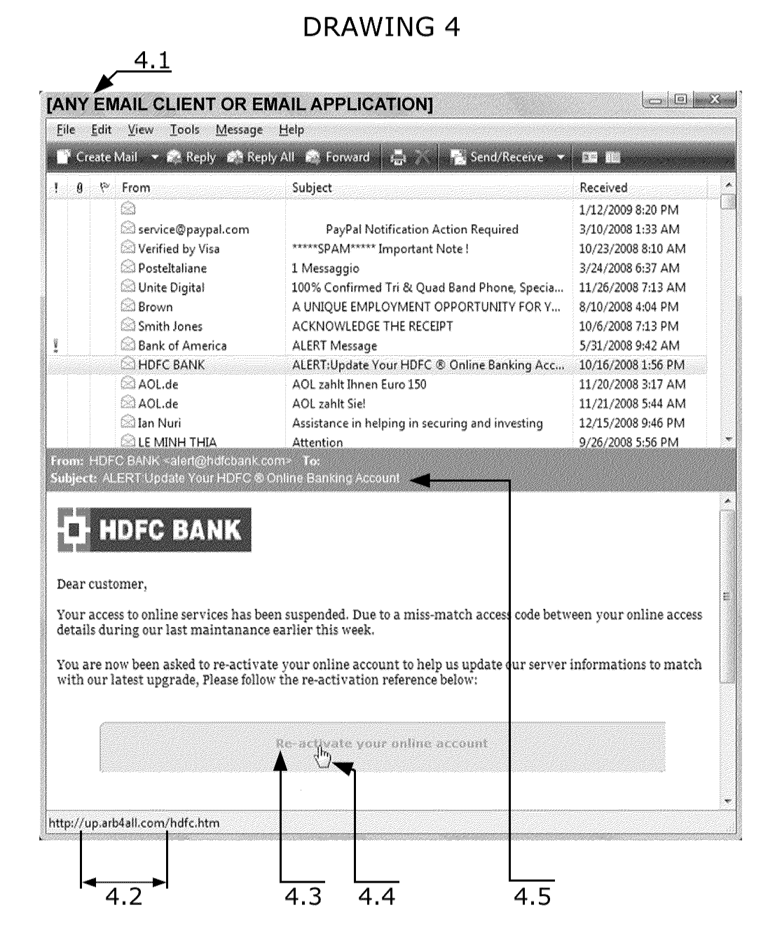

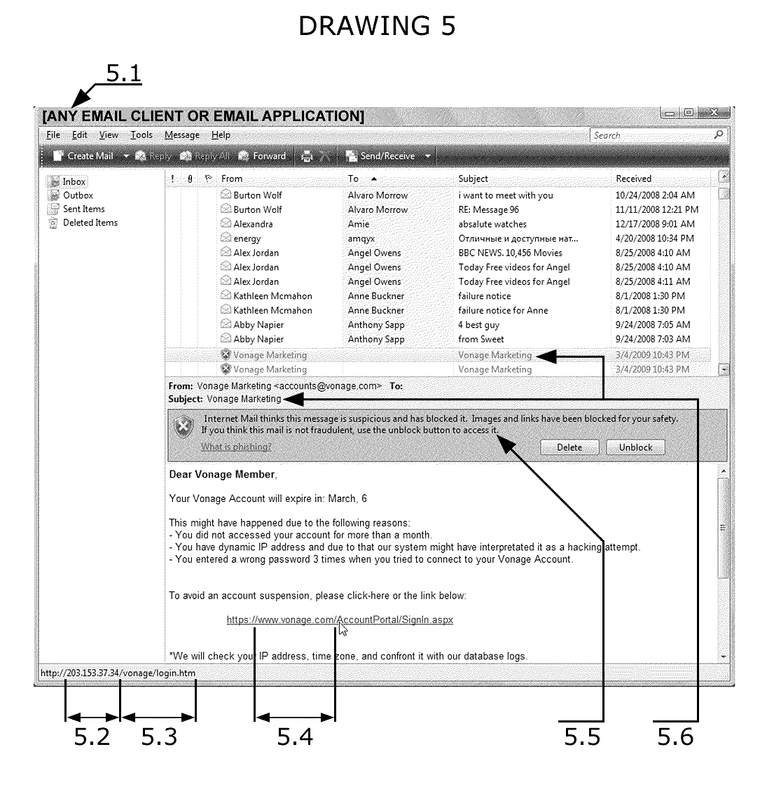

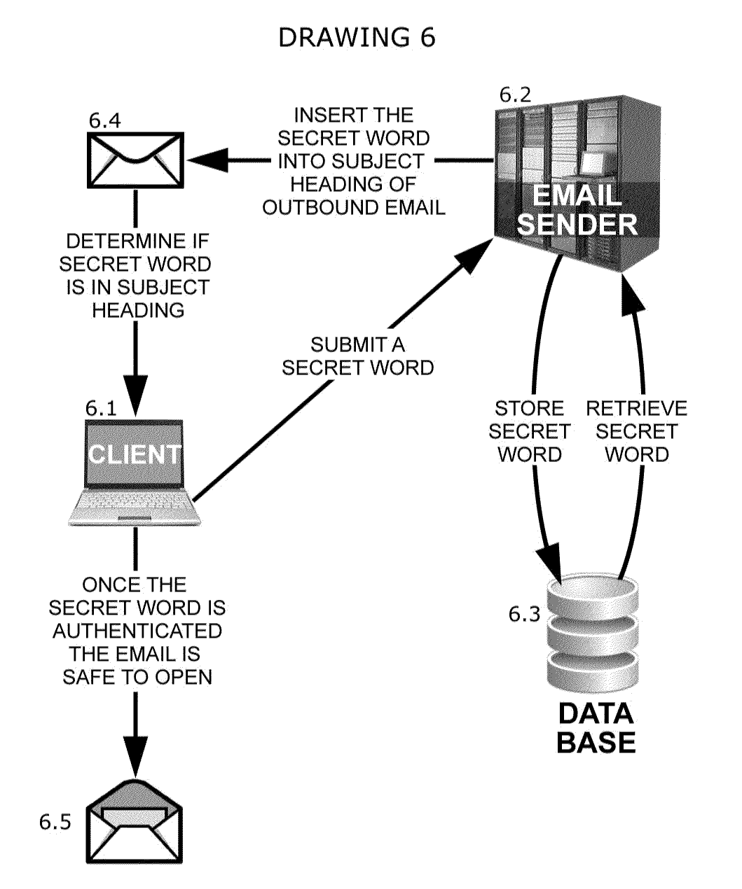

### FIELD OF THE INVENTION

This invention broadly relates to Email, also referred to as Electronic Mail, which is often transmitted and received via the Internet, local area networks or private networks.

### BACKGROUND OF THE INVENTION

Email, or Electronic Mail is a method of sending, processing and receiving digital messages from one computerized device to another. Email messages are routed among computerized devices or computerized systems with the help of what might be thought of as a sorting system or a computerized infrastructure that is responsible for directing, sorting and relaying these messages to their proper destination with the help of various different protocols, formats, and standards. To manage, generate, send, receive, reply, or forward an Email, a user must employ some variant of local computerized programming software or a remote computerized system that has been developed for this purpose, so that each Email sent and received can properly interface and comply with the rest of the global system.

This type of software when existing locally, has often been referred to as an “Email Client,” which performs in a similar fashion as a “web-based Email interface,” which constitutes a remote Email system accessible by using any “web browser” via the Internet or World Wide Web. There are many Email clients and many Email interfaces available throughout, which fuels the fundamental problem of not having one single, comprehensive universal Email security system. One of the most serious fundamental problems is that counterfeit Email can be transmitted largely unobstructed via the global Email networks.

Email messages contain what people today commonly refer to as “headers,” which are encoded into each message but typically are not displayed within the visible content of a message. These headers contain all of the routing, origin and destination information about each Email message. Available within each different Email client and Email system are various options and abilities that allow a Sender to manipulate the headers of an outgoing Email to disguise its true origin. Many individuals wishing to manipulate Email encoding and send out large volumes of illegitimate Email have been known to program their own Email client computer applications to serve whatever devious purpose they choose.

The recipient of an Email can view various headers of information about the Email before opening it. Typically, this includes the “To,” the “From,” and the “Subject” headings, plus other attributes. When evaluating incoming Email, a recipient typically will observe the “From” and the “Subject” headings to determine whether an Email is legitimate or of interest. Using psychology as a weapon, criminals devise careful “From” and “Subject” headers for their outgoing Emails, with the intent to confuse the recipient into thinking the Email is legitimate. Even though an Email is sent from one Email address, a Sender can forge the Email headers to display to the recipient an entirely different Email address. Similarly, the “To” header can also be manipulated without control. These vulnerabilities in the global Email system contribute to a largely un-patrolled and potentially dangerous Email system for all users. To make matters worse, many legitimate Senders have made a practice of manipulating the Email headers for various well-intentioned reasons, which makes it even more difficult for a Client to distinguish between real and fake correspondence.

The term “phishing” is a new internet-era term for the creation and use by criminals of e-mails and websites that are designed to look like they belong to well-known, legitimate and trusted businesses, financial institutions and government agencies—in an attempt to gather personal, financial and sensitive information. These criminals use luring techniques to deceive internet users into disclosing their banking and financial information or other secure information such as usernames and passwords, or into unwittingly downloading malicious computer code onto their computers that can allow the criminals subsequent access to those computers or the users' financial accounts.

“Phishing” is committed so that the criminal may obtain sensitive and valuable information about a person, government, company or organization, usually with a goal of fraudulently obtaining access to bank or other financial accounts. Often “phishers” will sell credit card or account numbers to other criminals. Almost every department within the United States government has warnings posted on their websites about these specific hazards.

Criminals who want to obtain personal data from people online first create unauthorized replicas of (or “spoof”) a real website and the content of an e-mail, typically from a financial institution (4.5) or another company that deals with financial information, such as an online merchant. The e-mail will be created in the style of e-mails likely to be used by a legitimate company or agency, combined with fake Email headers to make it appear as if the Email address is truly from that company. “Phishing,” by its nature, involves public misuse of legitimate companies' and agencies' names and logos.

“Phishers” typically send “spoofed” e-mails (Drawing 4 and 5) to as many people as possible in an attempt to lure them into the scheme. In some attacks, phishers have used other illegal means to obtain personal information about a specific group of people, and then targeted that group with e-mails that include illegally obtained information to make the e-mails appear more plausible. These e-mails redirect intended victims to a “spoofed” website, appearing to be from that same business or entity. The criminals know that while not all recipients will have accounts or other existing relationships with these companies, some of them actually will and therefore are more likely to believe the e-mail and websites to be legitimate.

The problem continues to escalate as more and more people are tricked into supplying personal information. There are two main ways that these schemes gain the trust of their victims.

First, “phishing” solicitations often use familiar corporate trademarks and trade names, as well as recognized government agency names and logos. The use of such trademarks is effective in many cases because they are familiar to many Internet users and are more likely to be trusted without closer scrutiny by the users. Victims typically provide their personal information to phishers because they believe the solicitation to be trustworthy and are unaware that an Email can be counterfeited to look like it came from one Email address while actually originating from somewhere entirely clandestine.

Second, the solicitations routinely contain warnings intended to cause the recipients immediate concern or worry about access to an existing financial account. Phishing scams typically create a sense of urgency by warning victims that their failure to comply with instructions will lead to account terminations, the assessment of penalties or fees, or other adverse outcomes. This fear that such warnings create helps to further cloud the ability of consumers to judge whether the messages are authentic. Even if a small percentage of people who receive these fraudulent warnings respond, the ease with which such solicitations can be distributed to millions of people creates an unusually large potential number of victims.

There is another technique whereby e-mails that appear genuine are sent to all the employees or members within a certain company, government agency, organization, or group. Much like a standard phishing e-mail, the message might look like it comes from an employer, or from a colleague who might send an e-mail message to everyone in the company, in an attempt to gain login information. These scams work to gain access to a company's entire computer system.

Yet another scheme involves identity thieves sending an e-mail designed in the same way as a phishing e-mail, yet instead of providing a fraudulent link to click on, the e-mail provides a customer service number that the client must call and is then prompted to “log in” using account numbers and passwords. Alternately, consumers are called directly and told that they must call a fraudulent customer service number immediately in order to protect their account.

The Phishing problem is very serious and has been difficult to combat for various reasons. Email recipients often lack the tools and technical knowledge to authenticate messages from financial institutions and e-commerce companies. In addition, the available tools and techniques used today are inadequate for Email authentication, or can simply be defeated.

Criminals can use techniques such as forging e-mail headers, subject lines and hyper link targets (4.2) to make the e-mails appear to come from trusted sources, knowing that many recipients will have no effective way to reject the legitimacy of such e-mails. The link text or link image displayed within the body of the Email is often masked to look authentic, (5.4) but by hovering the computer's mouse over the visible link (4.4) in some Email client applications, this will unveil the true link target, (4.2) even though sometimes that too can be planted to include part of the spoofed company's name, (5.3) only to lead to a completely different IP or web address. (5.2)

If a victim passes their eyes across this type of fraudulent link target too quickly, they are very likely to overlook obvious discrepancies in the URL or domain name, particularly considering that most people do not realize that a genuine domain name is found to the right of any sub-domains and directly to the left of the first lone forward slash (/). As an example, the web address: “WALTREISS.COM.user-login.wsr.cn/takeover/account.htm” could easily be mistaken as the legitimate WALTREISS.COM domain name due to the placement of “WALTREISS.COM” in the beginning of this URL address, but what most Email recipients still remain oblivious to is the fact that the actual domain name is buried amid all of the carefully formulated jargon. In this demonstration, the actual domain name masked within this hyper link is “wsr.cn,” which would lead the victim to a spoofed site.

This current invention was devised to offer a reasonable, quick and highly effective solution to the significant problems that are caused by criminals hoping to take advantage of unsuspecting Email recipients. This invention cannot prevent unwanted Email from ultimately being delivered to a recipient, but, when properly implemented, this invention can offer the recipient the ability to instantly differentiate between legitimate (2.2) and illegitimate (5.6) Emails without needing to open a single Email.

Phishing and spoofing activities are entirely dependent on a Client's inability to authenticate the Sender of an Email. Once this system is implemented, provided that Clients are effectively and routinely reminded by Senders never to open unauthenticated Emails purporting to be from that Sender, and to not supply confidential information to unidentified callers without authentication, the invention has the potential to wipe out the success of phishing and spoofing practices entirely. This invention is unlikely to offer the desired benefits and safeguards until the computer systems of both the Client and the Sender are free of viruses, malicious software, Trojans, keystroke spying software and any other unwanted elements which may compromise security.

### SUMMARY OF THE INVENTION

This invention is a system and process for authenticating an Email Sender by having the Client (6.1) first provide to the Sender (6.2) a Secret Word (1.8) that the Sender will subsequently insert within the subject heading (Drawing 3) of all Email communication directed to that Client.

Any website, institution, service provider, seller, or any other entity that provides or attempts to provide any Client or other entity with secure access to any type of computerized system or account wherein access to that system or account is granted only upon successful identification of the Client or entity attempting to gain said access, will be hereinabove and hereinafter broadly referred to as a “Sender,” regardless of whether any communication is ever sent by a Sender. A Sender may exist in any number of forms, which shall include but should certainly not be limited to: any type of online or internet-based subscription service; an Email system or service; a financial institution, organization or service; a governmental department, service or entity; a private industry group, association or business; a social or social networking organization or service; an internet service provider, internet provider or Email provider, or any other provider of any account or service wherein that account or service is needed to be or intended to be secure or accessible by authorized persons only. A Sender shall also be defined as any account provider with the responsibility or duty to guard the security of a Client's information by taking measures to prevent any crook or criminal from defrauding or baiting Clients into disclosing secure access codes, login information or other private information necessary to gain unauthorized access to any accounts or information.

A “Client” will be hereinabove and hereinafter broadly defined as any recipient or potential recipient of any legitimate or fraudulent Email or other similar correspondence, and is further defined as, but in no way limited to, customers, account holders, members, users, subscribers, patrons, visitors, guests, associates, constituents, participants, taxpayers, volunteers, employees, agents, contractors, service providers or any other person or entity with, having had, or desiring secure access to any type of computerized system or account wherein access thereto is granted only upon the successful identification of the Client or entity attempting to gain said access. A Client shall also be defined but not limited to any potential victim of fraud, identity theft, spoofing, phishing, hacking or of any other criminal or malicious behavior that is dependant upon or contingent upon the Client's accidental, unwanted or unintentional disclosure, theft or loss of a username, password, login information, secret code, account codes or any other ways or means of circumventing a secure identification process or procedure that would otherwise prevent unauthorized access to the Client's confidential information or protected accounts.

A “Secret Word” will be hereinabove and hereinafter broadly defined as any unique word, term, phrase, number, symbol, character, letter, code or any combination thereof that any Client may create, assemble or invent. A Secret Word will be supplied by each Client to each different Sender for insertion within the subject heading of all Email communications originating from that Sender, thereby enabling the Client to authenticate the source of each Email and differentiate from any potentially fraudulent messages requiring deletion.

It should be understood that for the purposes of this invention a Sender may not necessarily have ever dispatched a single Email to any Client and may not ever intend to. In fact, the Clients of a Sender that never sends any Email communication may be even more susceptible to fraud because of the greater difficulty they would likely have in distinguishing between a legitimate and illegitimate Email message or similar correspondence. In this scenario it is even more important to implement an anti-phishing system for the benefit of all Clients as a proactive measure of preventing fraud.

Throughout the existence of the internet, many companies and inventors have attempted to create various indirect, overly technical or highly complicated remedies for the problem of “phishing” and “spoofing.” All of the previous attempts have had a negligible impact in preventing these illegal activities from occurring on a seemingly perpetual basis. This current invention presents a simple, inexpensive, effective, and yet widely overlooked solution to this very significant and costly problem.

The foregoing is a summary and thus contains, by necessity, simplifications, generalizations and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

Drawing 1—In support of this invention, this drawing generically represents the proposed use of any typical internet browser (1.1) to access any typical internet website or similar data collection interface provided by a Sender for the purpose of allowing a Client to create and submit a Secret Word (1.8) to the Sender.

Drawing 2—In support of this invention, this drawing demonstrates the ability to visually authenticate incoming Email while using any Email client or web-based Email (2.1) by verifying that a Secret Word both exists in the subject of the Email (2.2) as well as matches the Secret Word supplied by the Client (1.8).

Drawing 3—As part of this invention, this drawing represents a typical independent Email being used to demonstrate the intended visibility that the Secret Word (3.2) has as it appears within the subject heading.

Drawing 4—In identifying the underlying problem for which this invention was created to resolve, this drawing depicts any typical Email client (4.1) containing an assortment of “phishing” and Unsolicited Commercial Emails, but specifically intends to show how the purported function (4.3) of the visible hyper-link within a “phishing” Email does not correspond with the underlying hyper link address (4.2) that the criminal hopes the Client will click on and inadvertently visit. A genuine link target is sometimes visible by hovering the mouse cursor over the hyper-link included within the message. (4.4)

Drawing 5—In identifying the underlying problem for which this invention was created to resolve, this drawing depicts any typical Email client or application (5.1) containing an assortment of “phishing” and Unsolicited Commercial Emails, but further demonstrates the absence of a Secret Word (5.6) in the subject heading. This drawing also provides another example of how a criminal attempts to use “phishing” tricks to display a prima facie legitimate hyper link address (5.4) within the body of the Email while masking the true hyper link target address (5.2) and creating the illusion of legitimacy by employing the name of the actual company being spoofed within the hyper link address. (5.3)

Drawing 6—In support of this invention, this drawing demonstrates the invention's basic process, comprising: the Client (6.1) submits a Secret Word to the Sender; (6.2) the Sender deposits the Secret Word into a database (6.3) and retrieves it as needed; correspondence is dispatched (6.4) to the Client containing the Secret Word; the Client verifies the presence and accuracy of the Secret Word, and can then safely authenticate the Sender and open the correspondence. (6.5)

### DETAILED DESCRIPTION OF THE INVENTION

The invention is designed for the simple purpose of allowing a Client to visually authenticate the origin of legitimate Email sent by a known or trusted Sender. The Sender (6.2) will first require that all Clients (6.1) provide to them a unique Secret Word that shall be used by the Sender as a security feature at all times when sending Email or any other potentially “spoofable” correspondence to the Client. The Sender will collect each Client's Secret Word in a secure manner and and store it in a secure location. (6.3) When an Email is intended to be dispatched to a Client, the Secret Word selected by that Client is retrieved securely from storage by the Sender and inserted into the subject heading of the Email, after which it shall be dispatched to the Client (6.4) for visual authentication. (6.5)

An important part of this invention and process is the periodic notification by each Sender to each Client that safety and security improvements have been made, and that once the Sender is supplied with a Secret Word, no Email or similar correspondence will ever be dispatched to the Client without a Secret Word appearing in the subject heading, and that all Email or similar correspondence purporting to represent that Sender that does not contain the Client's current Secret Word must be dismissed without question as being fraudulent and immediately deleted or forwarded to the proper authorities.

This invention is designed to be virtually impossible to bypass, defeat or crack by virtue of the fact that the Client will create their own Secret Word, which cannot be spoofed or faked. Only the Client location and the Sender should know the one correct Secret Word. Due to the existence of hundreds of thousands of individual words in every language, which will likely be creatively combined by Clients with other characters, symbols or numbers, the only way a “phishing” Email could ever possibly contain the correct Secret Word would be if millions of sequential guesses were all Emailed to the same client. Of course, this sort of profound effort would not only shut down the Email server local to the criminal regardless, but also the Client would have clear evidence of fraud after the first few hundred identical messages with incorrect sequential Secret Words flood their inbox. Therefore, the ability to trick a Client into opening a “phishing” Email by correctly supplying their Secret Word remains virtually inconceivable. The only exception would be if a virus or other malicious code or keystroke monitoring software were to infect the computer system of either the Client or the Sender, which may compromise the current Secret Word. This scenario would require that a new Secret Word be created immediately following the successful decontamination of each infected computer or system.

To implement this invention and correspondence authentication system, the Sender may elect to provide each Client with access to a simple, local-based, network-based, world-wide-web-based or internet-based interface (1.1) that can be utilized by the Client to securely submit (1.7) their Secret Word (1.8) selection to the Sender. To ensure the security of this process, any new system or existing system that is modified to collect the Secret Word should always be presented in a secured, password protected area within the Sender's system or website. Typically, this shall be in an area reserved for activity such as an account signup or setup process, the collection or maintenance of a Client's contact or account information, or within the Client's account management area (1.2). Ultimately, the Secret Word may be collected from the Client in whatever secure area contains the Client's account user name (1.3) and Email address. (1.4)

In order to create the interface and database for the collection and maintenance of the Secret Word information, the Sender will instruct their developers or programmers to either create a new system or modify their existing system to include additional data fields, both on the Sender's website and within their database, including any scripts or programming needed to securely collect, store and retrieve the Secret Word. The developers or programmers shall also include within this selected area detailed instructions (1.5) to each Client as they see fit, including no less than: a description of the “phishing” epidemic, the reason for collecting a Secret Word, how the Secret Word will be used, how often it should be changed, cautions against forwarding Emails with a Secret Word in tact, and what the Secret Word will look like as displayed in an Email. They must also inform each Client of the Client's responsibility to authenticate all incoming Email or similar correspondence from that point forward and to never open any message purporting to originate from that Sender if the Client's Secret Word does not appear within the subject heading.

Additionally, a Sender may wish to allow a Client to supply multiple Secret Words and designate specific uses or attributes for each. This may be useful for a Client to be able to assign different Secret Words to identify different types of official Sender correspondence, or to authenticate specific users at the Sender's location. Moreover, the Sender may wish to allow the collection of multiple Secret Words as part of an event-based or automated transition from an existing Secret Word to the next Secret Word on file.

The Sender may elect to provide each Client with alternative options for the collection of Secret Word information. One other simple option would be to collect this information in person, such as would be possible when the Sender happens to be a financial institution with physical locations that customers visit to conduct their affairs. Gathering Secret Word information may also be performed by telephone or facsimile, or any other reliable and secure means of communication between a Sender and Client. Regardless of which method of communication is used to gather Secret Word information, the process will remain the same. The Secret Word information should be collected from the Client and stored by the Sender until needed for the purpose of dispatching one or more Emails to the Client, if ever, and if no Emails are ever sent, it will simply allow the Client to identify and disregard spoofed Emails by virtue of the absence of a Secret Word.

The Sender may store the Secret Word information using whatever secure means are deemed appropriate by the Sender. The most reasonable means of storing and securing the Secret Word selections from each Client would be within a secure database (6.3) under the ownership or control of the Sender (6.2), so that existing Client data can be easily amended to include their Secret Word selections.

When the Sender intends to dispatch an Email to a Client, they will retrieve the Client's Secret Word and insert it into whatever position they desire within the subject heading of the intended Email. It is intended that the Secret Word appear between a pair of square brackets for ease of identification, and also that the Secret Word be inserted to begin anywhere within the first 20 characters of the subject heading in order to prevent the Secret Word from being visually obscured by neighboring columns on the right as could occur within an Email client. (2.2)

The insertion of a Secret Word into a subject heading may be performed manually, although this may be very time consuming depending on the number of Client Emails being dispatched. The optimal choice would be to create a simple computer script compatible with the Sender's local system and database that will automatically retrieve both the Client's Secret Word and their Email address from the database and insert them into the intended Email simultaneously. Once the Secret Word is inserted into the subject heading of the Email and the Sender's content is included, the Email is now prepared to be dispatched. (6.4)

Some online Senders do not send any Email communication to Clients who nonetheless have secure access to a private account. Despite any impression that this invention would not apply to such a scenario, this is definitely not the case. “Phishing” and “Spoofing” tricks and techniques (4.3 and 5.4) are not limited only to those Senders that happen to send Email or other potentially “spoofable” correspondence to Clients. If secure access exists for any person for any account—even without regular correspondence from the Sender—it is important to understand the inherent risks that exist when any Client receives one single fake, yet believable Email (4.5) that appears to come from that Sender.

A Client may be even more susceptible than usual to believing that the Email is legitimate when it happens to be the first Email notification they receive from a Sender because the Client will undoubtedly assume that they must have provided their Email address to the Sender in the past. For fraud to occur, a thief only needs to know of the existence of an online login page, after which the thief will typically dispatch millions of identical Emails appearing to be from that account provider, just like a fishing net, hoping to catch a few victims who follow the link within the Email (5.4) and submit their genuine username and password on the “spoofed” copy of the account provider's authentic login page.

This invention is designed to create a secure relationship between a Sender and a Client. This relationship is such that the Client agrees to never open or explore any Email appearing to come from the Sender without first authenticating each communication and does so by confirming the presence and accuracy of their Secret Word. A Sender agrees never to send Emails or similar correspondence to the Client without the required Secret Word. This relationship may also be valuable when applied to phone calls received by a Client from a person claiming to be the Sender. Before personal, sensitive or confidential information is disclosed to a purported Sender, the Client may wish to challenge the Sender by requiring that the Secret Word be validated.

By following this simple system, the Sender will prevent problems known to exist when their Clients are unable to distinguish between legitimate Sender communications (2.2) and those sent by criminals and “identity thieves” (5.6) attempting to steal passwords, account information, personal information, funds and virtually anything else of perceived value. By allowing the Client to select their own Secret Word, the burden will now rest upon the Sender to prove to the Client that their Email is legitimate by presenting this Secret Word back to the Client for authentication. This process is very similar to when a customer service representative receives a call from a customer, but must first require the customer to verify their identity before discussing account information.

The intent in creating a Secret Word is not for the Client to make use of a secure password, but merely to select any arbitrary but easily identifiable Secret Word that can be discarded and changed at will. A Secret Word is created for and exists for the sole purpose of affirming to an Email recipient that the Email they received in their inbox could have come from only one place. The Secret Word is not designed to, nor should it provide access or privileges in any way, because it cannot be kept secure among a Client's family, coworkers or friends who may share the same computer or may casually observe the Client's Email account. It is presumed that those individuals sharing close quarters with a Client would not be inclined to contact the nearest identity thief to tip them off to the discovery of a single Client's current Secret Word for one particular Sender so that they can quickly establish a spoofed website and send a phishing message including that Secret Word, although this would greatly reduce the list of suspects for the authorities to investigate if it were to occur.

The implementation of the solution defined hereinbefore can be easily understood and is easily implemented by those individuals employed within the various facets of Computer Sciences, whereas the invention itself remains neutral and unspecific as to which computer programming languages, standards, equipment, applications, hardware or software are ultimately selected to implement the invention due to the existence of abundant options available for doing so.

### Bibliography:

Report on Phishing: A Report to the Minister of Public Safety and Emergency Preparedness Canada and the Attorney General of the United States. Bi-national Working Group on Cross-Border Mass Marketing Fraud, October 2006, Available from http://www.usdoj.gov/opa/report_on_phishing.pdf

1. An Email safety and Sender authentication system, comprising: a Sender will collect one or more Secret Words from a Client using an internet website interface, telephone, or any other means of communication; the Sender will store the Secret Word information in a secure location such as a database; the Sender will retrieve the respective Secret Word from storage and will insert it as part of the subject heading of all Email dispatched to the Client; the Email containing the Secret Word is then delivered to the Client to be visually authenticated before opening.

2. An Email safety and Sender authentication system, comprising: a Client will communicate with the Sender through whatever means necessary to provide to the Sender with one or more Secret Words; the Client will visually inspect the subject heading of all incoming Emails to verify that a Secret Word is both present and matches the Secret Word provided to the Sender; once authenticated, the Client can open the Email.
